(19) United States
(12) Patent Application Publication
(10) Pub. No.: US 2011/0091346 A1
(43) Pub. Date: Apr. 21, 2011

(54) Forging deformation of L12 aluminum alloys

(75) Inventor: Awadh B. Pandey, Jupiter, FL (US)

(73) Assignee: United Technologies Corporation, Hartford, CT (US)

(21) Appl. No.: 12/589,105

(22) Filed: Oct. 16, 2009

(51) Int. Cl. B22F 3/24; B22F 1/00; B32B 15/02

(52) U.S. Cl. 419/28; 75/228; 75/235; 75/236; 75/244

(57) ABSTRACT

A method for producing a high strength aluminum alloy parts containing L1₂ dispersoids from an aluminum alloy powder containing the L1₂ dispersoids. The powder is consolidated into a billet having a density of about 100 percent. The billet is extruded using an extrusion die shaped to produce a forging billet. The L1₂ alloy billet is isothermally forged to produce a forging with improved mechanical properties.

### CROSS-REFERENCE TO RELATED APPLICATION(S)

This application is related to the following co-pending applications that were filed on Dec. 9, 2008 herewith and are assigned to the same assignee: CONVERSION PROCESS FOR HEAT TREATABLE L1₂ ALUMINUM ALLOYS, Ser. No. 12/316,020; A METHOD FOR FORMING HIGH STRENGTH ALUMINUM ALLOYS CONTAINING L1₂ INTERMETALLIC DISPERSOIDS, Ser. No. 12/316,046; and A METHOD FOR PRODUCING HIGH STRENGTH ALUMINUM ALLOY POWDER CONTAINING L1₂ INTERMETALLIC DISPERSOIDS, Ser. No. 12/316,047.

This application is also related to the following co-pending applications that were filed on Apr. 18, 2008, and are assigned to the same assignee: L1₂ ALUMINUM ALLOYS WITH BIMODAL AND TRIMODAL DISTRIBUTION, Ser. No. 12/148,395; DISPERSION STRENGTHENED L1₂ ALUMINUM ALLOYS, Ser. No. 12/148,432; HEAT TREATABLE L1₂ ALUMINUM ALLOYS, Ser. No. 12/148,383; HIGH STRENGTH L1₂ ALUMINUM ALLOYS, Ser. No. 12/148,394; HIGH STRENGTH L1₂ ALUMINUM ALLOYS, Ser. No. 12/148,382; HEAT TREATABLE L1₂ ALUMINUM ALLOYS, Ser. No. 12/148,396; HIGH STRENGTH L1₂ ALUMINUM ALLOYS, Ser. No. 12/148,387; HIGH STRENGTH ALUMINUM ALLOYS WITH L1₂ PRECIPITATES, Ser. No. 12/148,426; HIGH STRENGTH L1₂ ALUMINUM ALLOYS, Ser. No. 12/148,459; and L1₂ STRENGTHENED AMORPHOUS ALUMINUM ALLOYS, Ser. No. 12/148,458.

### BACKGROUND

The present invention relates generally to aluminum alloys and more specifically to a method for forming high strength aluminum alloy powder having L1₂ dispersoids therein into useful parts.

The combination of high strength, ductility, and fracture toughness, as well as low density, make aluminum alloys natural candidates for as variety of applications. Because of its low weight high strength, ductility and fracture toughness, aluminum alloys are of interest in the manufacture and use for many applications.

The development of aluminum alloys with improved elevated temperature mechanical properties is a continuing process. Some attempts have included aluminum-iron and aluminum-chromium based alloys such as Al—Fe—Ce, Al—Fe—V—Si, Al—Fe—Ce—W, and Al—Cr—Zr—Mn that contain incoherent dispersoids. These alloys, however, also lose strength at elevated temperatures due to particle coarsening. In addition, these alloys exhibit ductility and fracture toughness values lower than other commercially available aluminum alloys.

Other attempts have included the development of mechanically alloyed Al-Mg and Al—Ti alloys containing ceramic dispersoids. These alloys exhibit improved high temperature strength due to the particle dispersion, but the ductility and fracture toughness are not improved.

U.S. Pat. No. 6,248,453 discloses aluminum alloys strengthened by dispersed Al₃X L1₂ intermetallic phases where X is selected from the group consisting of Sc, Er, Lu, Yb, Tm, and Lu. The Al₃X particles are coherent with the aluminum alloy matrix and are resistant to coarsening at elevated temperatures. The improved mechanical properties of the disclosed dispersion strengthened L1₂ aluminum alloys are stable up to 572° F. (300° C.). U.S. Patent Application Publication No. 2006/0269437 A1 discloses a high strength aluminum alloy that contains scandium and other elements that is strengthened by L1₂ dispersoids.

L1₂ strengthened aluminum alloys have high strength and improved fatigue properties compared to commercial aluminum alloys. Fine grain size results in improved mechanical properties of materials. Hall-Petch strengthening has been known for decades where strength increases as grain size decreases. An optimum grain size for optimum strength is in the nano range of about 30 to 100 nm. These alloys also have higher ductility.

### SUMMARY

The present invention is a method for consolidating aluminum alloy powders into useful components having improved strength and fracture toughness. In embodiments, powders include an aluminum alloy having coherent L1₂ Al₃X dispersoids where X is at least one first element selected from scandium, erbium, thulium, ytterbium, and lutetium, and at least one second element selected from gadolinium, yttrium, zirconium, titanium, hafnium, and niobium. The balance is substantially aluminum containing at least one alloying element selected from silicon, magnesium, manganese, lithium, copper, zinc, and nickel.

The aluminum alloy parts are formed by isothermal forging of consolidated billets. Isothermal forging of these alloys produces considerable improvement in mechanical properties, especially ductility compared to the consolidated billet. Forging parameters include billet temperature, billet soak time, forging rate, reduction and die temperature.

### BRIEF DESCRIPTION OF THE DRAWINGS

FIG. 1 is an aluminum scandium phase diagram.

FIG. 2 is an aluminum erbium phase diagram.

FIG. 3 is an aluminum thulium phase diagram.

FIG. 4 is an aluminum ytterbium phase diagram.

FIG. 5 is an aluminum lutetium phase diagram.

FIG. 6A is a schematic diagram of a vertical gas atomizer.

FIG. 6B is a close up view of nozzle 108 in FIG. 6A.

FIGS. 7A and 7B are SEM photos of the inventive aluminum alloy powder.

FIGS. 8A and 8B are optical micrographs showing the microstructure of gas atomized L1₂ aluminum alloy powder.

FIG. 9 is a diagram showing the steps of the gas atomization process.

FIG. 10 is a diagram showing the processing steps to consolidate the L1₂ aluminum alloy powder.

FIG. 11 is a schematic diagram of blind die compaction.

FIG. 12 is a schematic diagram of a forging process.

FIG. 13A is a photo of a L1₂ aluminum alloy pancake forging.

FIGS. 13B and 13C are photos of an L1₂ aluminum alloy turbine rotor.

### DETAILED DESCRIPTION

### 1. L1₂ Aluminum Alloys

Alloy powders of this invention are formed from aluminum based alloys with high strength and fracture toughness for applications at temperatures from about −420° F. (−251° C.) up to about 650° F. (343° C.). The aluminum alloy comprises a solid solution of aluminum and at least one element selected from silicon, magnesium, lithium, copper, zinc, and nickel strengthened by L1₂ Al₃X coherent precipitates where X is at least one first element selected from scandium, erbium, thulium, ytterbium, and lutetium, and at least one second element selected from gadolinium, yttrium, zirconium, titanium, hafnium, and niobium.

The alloys may also include at least one ceramic reinforcement. Aluminum oxide, silicon carbide, aluminum nitride, titanium diboride, boron carbide and titanium carbide are suitable ceramic reinforcements.

The binary aluminum magnesium system is a simple eutectic at 36 weight percent magnesium and 842° F. (450° C.). There is complete solubility of magnesium and aluminum in the rapidly solidified inventive alloys discussed herein.

The binary aluminum silicon system is a simple eutectic at 12.6 weight percent silicon and 1070.6° F. (577° C.). There is complete solubility of silicon and aluminum in the rapidly solidified inventive alloys discussed herein.

The binary aluminum manganese system is a simple eutectic at about 2 weight percent manganese and 1216.4° F. (658° C.). There is complete solubility of manganese and aluminum in the rapidly solidified inventive alloys discussed herein.

The binary aluminum lithium system is a simple eutectic at 8 weight percent lithium and 1105° (596° C.). The equilibrium solubility of 4 weight percent lithium can be extended significantly by rapid solidification techniques. There is complete solubility of lithium in the rapid solidified inventive alloys discussed herein.

The binary aluminum copper system is a simple eutectic at 32 weight percent copper and 1018° F. (548° C.). There is complete solubility of copper in the rapidly solidified inventive alloys discussed herein.

The aluminum zinc binary system is a eutectic alloy system involving a monotectoid reaction and a miscibility gap in the solid state. There is a eutectic reaction at 94 weight percent zinc and 718° F. (381° C.). Zinc has maximum solid solubility of 83.1 weight percent in aluminum at 717.8° F. (381° C.), which can be extended by rapid solidification processes. Decomposition of the supersaturated solid solution of zinc in aluminum gives rise to spherical and ellipsoidal GP zones, which are coherent with the matrix and act to strengthen the alloy.

The aluminum nickel binary system is a simple eutectic at 5.7 weight percent nickel and 1183.8° F. (639.9° C.). There is little solubility of nickel in aluminum. However, the solubility can be extended significantly by utilizing rapid solidification processes. The equilibrium phase in the aluminum nickel eutectic system is L1₂ intermetallic Al₃Ni.

In the aluminum based alloys disclosed herein, scandium, erbium, thulium, ytterbium, and lutetium are potent strengtheners that have low diffusivity and low solubility in aluminum. All these elements form equilibrium Al₃X intermetallic dispersoids where X is at least one of scandium, erbium, thulium, ytterbium, and lutetium, that have an L1₂ structure that is an ordered face centered cubic structure with the X atoms located at the corners and aluminum atoms located on the cube faces of the unit cell.

Scandium forms Al₃Sc dispersoids that are fine and coherent with the aluminum matrix. Lattice parameters of aluminum and Al₃Sc are very close (0.405 nm and 0.410 nm respectively), indicating that there is minimal or no driving force for causing growth of the Al₃Sc dispersoids. This low interfacial energy makes the Al₃Sc dispersoids thermally stable and resistant to coarsening up to temperatures as high as about 842° F. (450° C.). Additions of magnesium in aluminum increase the lattice parameter of the aluminum matrix, and decrease the lattice parameter mismatch further increasing the resistance of the Al₃Sc to coarsening. Additions of zinc, copper, lithium, silicon, manganese and nickel provide solid solution and precipitation strengthening in the aluminum alloys. These Al₃Sc dispersoids are made stronger and more resistant to coarsening at elevated temperatures by adding suitable alloying elements such as gadolinium, yttrium, zirconium, titanium, hafnium, niobium, or combinations thereof, that enter Al₃Sc in solution.

Erbium forms Al₃Er dispersoids in the aluminum matrix that are fine and coherent with the aluminum matrix. The lattice parameters of aluminum and Al₃Er are close (0.405 nm and 0.417 nm respectively), indicating there is minimal driving force for causing growth of the Al₃Er dispersoids. This low interfacial energy makes the Al₃Er dispersoids thermally stable and resistant to coarsening up to temperatures as high as about 842° F. (450° C.). Additions of magnesium in aluminum increase the lattice parameter of the aluminum matrix, and decrease the lattice parameter mismatch further increasing the resistance of the Al₃Er to coarsening. Additions of zinc, copper, lithium, silicon, manganese and nickel provide solid solution and precipitation strengthening in the aluminum alloys. These Al₃Er dispersoids are made stronger and more resistant to coarsening at elevated temperatures by adding suitable alloying elements such as gadolinium, yttrium, zirconium, titanium, hafnium, niobium, or combinations thereof that enter Al₃Er in solution.

Thulium forms metastable Al₃Tm dispersoids in the aluminum matrix that are fine and coherent with the aluminum matrix. The lattice parameters of aluminum and Al₃Tm are close (0.405 nm and 0.420 nm respectively), indicating there is minimal driving force for causing growth of the Al₃Tm dispersoids. This low interfacial energy makes the Al₃Tm dispersoids thermally stable and resistant to coarsening up to temperatures as high as about 842° F. (450° C.). Additions of magnesium in aluminum increase the lattice parameter of the aluminum matrix, and decrease the lattice parameter mismatch further increasing the resistance of the Al₃Tm to coarsening. Additions of zinc, copper, lithium, silicon, manganese and nickel provide solid solution and precipitation strengthening in the aluminum alloys. These Al₃Tm dispersoids are made stronger and more resistant to coarsening at elevated temperatures by adding suitable alloying elements such as gadolinium, yttrium, zirconium, titanium, hafnium, niobium, or combinations thereof that enter Al₃Tm in solution.

Ytterbium forms Al₃Yb dispersoids in the aluminum matrix that are fine and coherent with the aluminum matrix. The lattice parameters of Al and Al₃Yb are close (0.405 nm and 0.420 nm respectively), indicating there is minimal driving force for causing growth of the Al₃Yb dispersoids. This low interfacial energy makes the Al₃Yb dispersoids thermally stable and resistant to coarsening up to temperatures as high as about 842° F. (450° C.). Additions of magnesium in aluminum increase the lattice parameter of the aluminum matrix, and decrease the lattice parameter mismatch further increasing the resistance of the Al₃Yb to coarsening. Additions of zinc, copper, lithium, silicon, manganese and nickel provide solid solution and precipitation strengthening in the aluminum alloys. These Al₃Yb dispersoids are made stronger and more resistant to coarsening at elevated temperatures by adding suitable alloying elements such as gadolinium, yttrium, zirconium, titanium, hafnium, niobium, or combinations thereof that enter Al₃Yb in solution.

Lutetium forms Al₃Lu dispersoids in the aluminum matrix that are fine and coherent with the aluminum matrix. The lattice parameters of Al and Al₃Lu are close (0.405 nm and 0.419 nm respectively), indicating there is minimal driving force for causing growth of the Al₃Lu dispersoids. This low interfacial energy makes the Al₃Lu dispersoids thermally stable and resistant to coarsening up to temperatures as high as about 842° F. (450° C.). Additions of magnesium in aluminum increase the lattice parameter of the aluminum matrix, and decrease the lattice parameter mismatch further increasing the resistance of the Al₃Lu to coarsening. Additions of zinc, copper, lithium, silicon, manganese and nickel provide solid solution and precipitation strengthening in the aluminum alloys. These Al₃Lu dispersoids are made stronger and more resistant to coarsening at elevated temperatures by adding suitable alloying elements such as gadolinium, yttrium, zirconium, titanium, hafnium, niobium, or mixtures thereof that enter Al₃Lu in solution.

Gadolinium forms metastable Al₃Gd dispersoids in the aluminum matrix that are stable up to temperatures as high as about 842° F. (450° C.) due to their low diffusivity in aluminum. The Al₃Gd dispersoids have a D0₁₉ structure in the equilibrium condition. Despite its large atomic size, gadolinium has fairly high solubility in the Al₃X intermetallic dispersoids (where X is scandium, erbium, thulium, ytterbium or lutetium). Gadolinium can substitute for the X atoms in Al₃X intermetallic, thereby forming an ordered L1₂ phase which results in improved thermal and structural stability.

Yttrium forms metastable Al₃Y dispersoids in the aluminum matrix that have an L1₂ structure in the metastable condition and a D0₁₉ structure in the equilibrium condition. The metastable Al₃Y dispersoids have a low diffusion coefficient, which makes them thermally stable and highly resistant to coarsening. Yttrium has a high solubility in the Al₃X intermetallic dispersoids allowing large amounts of yttrium to substitute for X in the Al₃X L1₂ dispersoids, which results in improved thermal and structural stability.

Zirconium forms Al₃Zr dispersoids in the aluminum matrix that have an L1₂ structure in the metastable condition and D0₂₃ structure in the equilibrium condition. The metastable Al₃Zr dispersoids have a low diffusion coefficient, which makes them thermally stable and highly resistant to coarsening. Zirconium has a high solubility in the Al₃X dispersoids allowing large amounts of zirconium to substitute for X in the Al₃X dispersoids, which results in improved thermal and structural stability.

Titanium forms Al₃Ti dispersoids in the aluminum matrix that have an L1₂ structure in the metastable condition and D0₂₂ structure in the equilibrium condition. The metastable Al₃Ti despersoids have a low diffusion coefficient, which makes them thermally stable and highly resistant to coarsening. Titanium has a high solubility in the Al₃X dispersoids allowing large amounts of titanium to substitute for X in the Al₃X dispersoids, which result in improved thermal and structural stability.

Hafnium forms metastable Al₃Hf dispersoids in the aluminum matrix that have an L1₂ structure in the metastable condition and a D0₂₃ structure in the equilibrium condition. The Al₃Hf dispersoids have a low diffusion coefficient, which makes them thermally stable and highly resistant to coarsening. Hafnium has a high solubility in the Al₃X dispersoids allowing large amounts of hafnium to substitute for scandium, erbium, thulium, ytterbium, and lutetium in the above-mentioned Al₃X dispersoids, which results in stronger and more thermally stable dispersoids.

Niobium forms metastable Al₃Nb dispersoids in the aluminum matrix that have an L1₂ structure in the metastable condition and a D0₂₂ structure in the equilibrium condition. Niobium has a lower solubility in the Al₃X dispersoids than hafnium or yttrium, allowing relatively lower amounts of niobium than hafnium or yttrium to substitute for X in the Al₃X dispersoids. Nonetheless, niobium can be very effective in slowing down the coarsening kinetics of the Al₃X dispersoids because the Al₃Nb dispersoids are thermally stable. The substitution of niobium for X in the above mentioned Al₃X dispersoids results in stronger and more thermally stable dispersoids.

The aluminum oxide, silicon carbide, aluminum nitride, titanium di-boride, titanium boride, boron carbide and titanium carbide locate at the grain boundary and within the grain boundary to restrict dislocations from going around particles of the ceramic particles when the alloy is under stress. When dislocations form, they become attached with the ceramic particles on the departure side. Thus, more energy is required to detach the dislocation and the alloy has increased strength. To accomplish this, the particles of ceramic have to have a fine size, a moderate volume fraction in the alloy, and form a good interface between the matrix and the reinforcement. A working range of particle sizes is from about 0.5 to about 50 microns, more preferably about 1 to about 20 microns, and even more preferably about 1 to about 10 microns. The ceramic particles can break during blending and the average particle size will decrease as a result.

Al₃X L1₂ precipitates improve elevated temperature mechanical properties in aluminum alloys for two reasons. First, the precipitates are ordered intermetallic compounds. As a result, when the particles are sheared by glide dislocations during deformation, the dislocations separate into two partial dislocations separated by an anti-phase boundary on the glide plane. The energy to create the anti-phase boundary is the origin of the strengthening. Second, the cubic L1₂ crystal structure and lattice parameter of the precipitates are closely matched to the aluminum solid solution matrix. This results in a lattice coherency at the precipitate/matrix boundary that resists coarsening. The lack of an interphase boundary results in a low driving force for particle growth and resulting elevated temperature stability. Alloying elements in solid solution in the dispersed strengthening particles and in the aluminum matrix that tend to decrease the lattice mismatch between the matrix and particles will tend to increase the strengthening and elevated temperature stability of the alloy.

L1₂ phase strengthened aluminum alloys are important structural materials because of their excellent mechanical properties and the stability of these properties at elevated temperature due to the resistance of the coherent dispersoids in the microstructure to particle coarsening. The mechanical properties are optimized by maintaining a high volume fraction of L1₂ dispersoids in the microstructure. The L1₂ dispersoid concentration following aging scales as the amount of L1₂ phase forming elements in solid solution in the aluminum alloy following quenching. Examples of L1₂ phase forming elements include but are not limited to Sc, Er, Th, Yb, and Lu. The concentration of alloying elements in solid solution in alloys cooled from the melt is directly proportional to the cooling rate.

Exemplary aluminum alloys for this invention include, but are not limited to (in weight percent unless otherwise specified):

about Al-M-(0.1-4)Sc-(0.1-20)Gd;

about Al-M-(0.1-20)Er-(0.1-20)Gd;

about Al-M-(0.1-15)Tm-(0.1-20)Gd;

about Al-M-(0.1-25)Yb-(0.1-20)Gd;

about Al-M-(0.1-25)Lu-(0.1-20)Gd;

about Al-M-(0.1-4)Sc-(0.1-20)Y;

about Al-M-(0.1-20)Er-(0.1-20)Y;

about Al-M-(0.1-15)Tm-(0.1-20)Y;

about Al-M-(0.1-25)Yb-(0.1-20)Y;

about Al-M-(0.1-25)Lu-(0.1-20)Y;

about Al-M-(0.1-4)Sc-(0.05-4)Zr;

about Al-M-(0.1-20)Er-(0.05-4)Zr;

about Al-M-(0.1-15)Tm-(0.05-4)Zr;

about Al-M-(0.1-25)Yb-(0.05-4)Zr;

about Al-M-(0.1-25)Lu-(0.05-4)Zr;

about Al-M-(0.1-4)Sc-(0.05-10)Ti;

about Al-M-(0.1-20)Er-(0.05-10)Ti;

about Al-M-(0.1-15)Tm-(0.05-10)Ti;

about Al-M-(0.1-25)Yb-(0.05-10)Ti;

about Al-M-(0.1-25)Lu-(0.05-10)Ti;

about Al-M-(0.1-4)Sc-(0.05-10)Hf;

about Al-M-(0.1-20)Er-(0.05-10)Hf;

about Al-M-(0.1-15)Tm-(0.05-10)Hf;

about Al-M-(0.1-25)Yb-(0.05-10)Hf;

about Al-M-(0.1-25)Lu-(0.05-10)Hf;

about Al-M-(0.1-4)Sc-(0.05-5)Nb;

about Al-M-(0.1-20)Er-(0.05-5)Nb;

about Al-M-(0.1-15)Tm-(0.05-5)Nb;

about Al-M-(0.1-25)Yb-(0.05-5)Nb; and about Al-M-(0.1-25)Lu-(0.05-5)Nb.

M is at least one of about (1-8) weight percent magnesium, (4-25) weight percent silicon, (0.1-3) weight percent manganese, (0.5-3) weight percent lithium, (0.2-6) weight percent copper, (3-12) weight percent zinc, and (1-12) weight percent nickel.

The amount of magnesium present in the fine grain matrix, if any, may vary from about 1 to about 8 weight percent, more preferably from about 3 to about 7.5 weight percent, and even more preferably from about 4 to about 6.5 weight percent.

The amount of silicon present in the fine grain matrix, if any, may vary from about 4 to about 25 weight percent, more preferably from about 5 to about 20 weight percent, and even more preferably from about 6 to about 14 weight percent.

The amount of manganese present in the fine grain matrix, if any, may vary from about 0.1 to about 3 weight percent, more preferably from about 0.2 to about 2 weight percent, and even more preferably from about 0.3 to about 1 weight percent.

The amount of lithium present in the fine grain matrix, if any, may vary from about 0.5 to about 3 weight percent, more preferably from about 1 to about 2.5 weight percent, and even more preferably from about 1 to about 2 weight percent.

The amount of copper present in the fine grain matrix, if any, may vary from about 0.2 to about 6 weight percent, more preferably from about 0.5 to about 5 weight percent, and even more preferably from about 2 to about 4.5 weight percent.

The amount of zinc present in the fine grain matrix, if any, may vary from about 3 to about 12 weight percent, more preferably from about 4 to about 10 weight percent, and even more preferably from about 5 to about 9 weight percent.

The amount of nickel present in the fine grain matrix, if any, may vary from about 1 to about 12 weight percent, more preferably from about 2 to about 10 weight percent, and even more preferably from about 4 to about 10 weight percent.

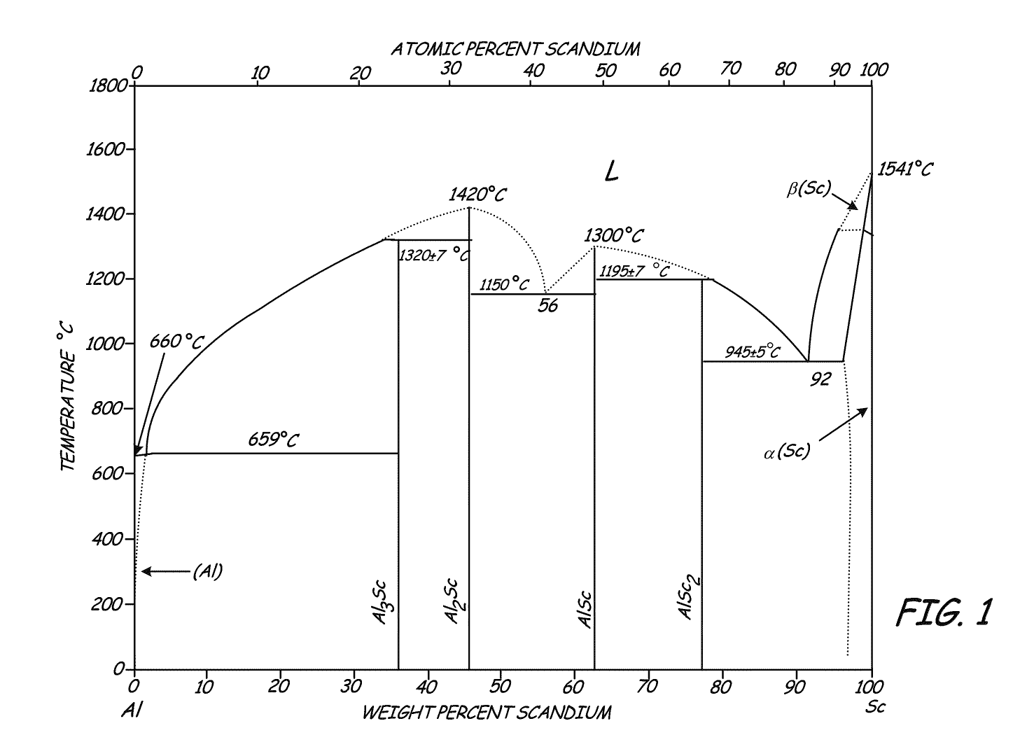

The amount of scandium present in the fine grain matrix, if any, may vary from 0.1 to about 4 weight percent, more preferably from about 0.1 to about 3 weight percent, and even more preferably from about 0.2 to about 2.5 weight percent. The Al—Sc phase diagram shown in FIG. 1 indicates a eutectic reaction at about 0.5 weight percent scandium at about 1219° F. (659° C.) resulting in a solid solution of scandium and aluminum and Al₃Sc dispersoids. Aluminum alloys with less than 0.5 weight percent scandium can be quenched from the melt to retain scandium in solid solution that may precipitate as dispersed L1₂ intermetallic Al₃Sc following an aging treatment. Alloys with scandium in excess of the eutectic composition (hypereutectic alloys) can only retain scandium in solid solution by rapid solidification processing (RSP) where cooling rates are in excess of about 10³° C./second.

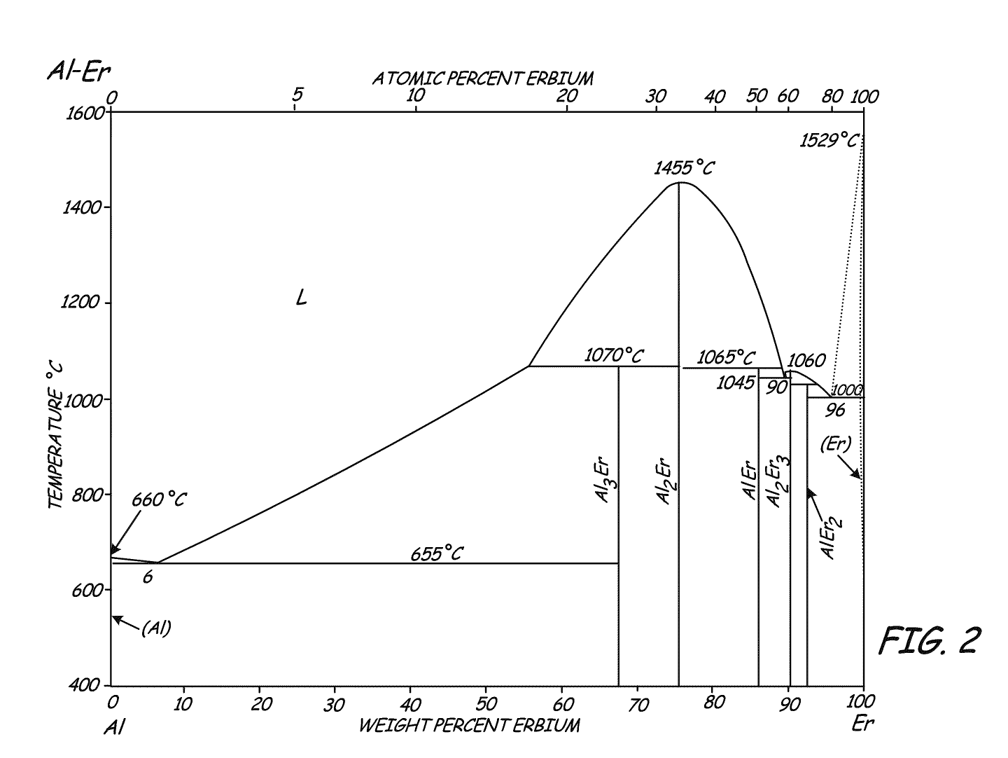

The amount of erbium present in the fine grain matrix, if any, may vary from about 0.1 to about 20 weight percent, more preferably from about 0.3 to about 15 weight percent, and even more preferably from about 0.5 to about 10 weight percent. The Al—Er phase diagram shown in FIG. 2 indicates a eutectic reaction at about 6 weight percent erbium at about 1211° F. (655° C.). Aluminum alloys with less than about 6 weight percent erbium can be quenched from the melt to retain erbium in solid solutions that may precipitate as dispersed L1₂ intermetallic Al₃Er following an aging treatment. Alloys with erbium in excess of the eutectic composition can only retain erbium in solid solution by rapid solidification processing (RSP) where cooling rates are in excess of about 10³° C./second.

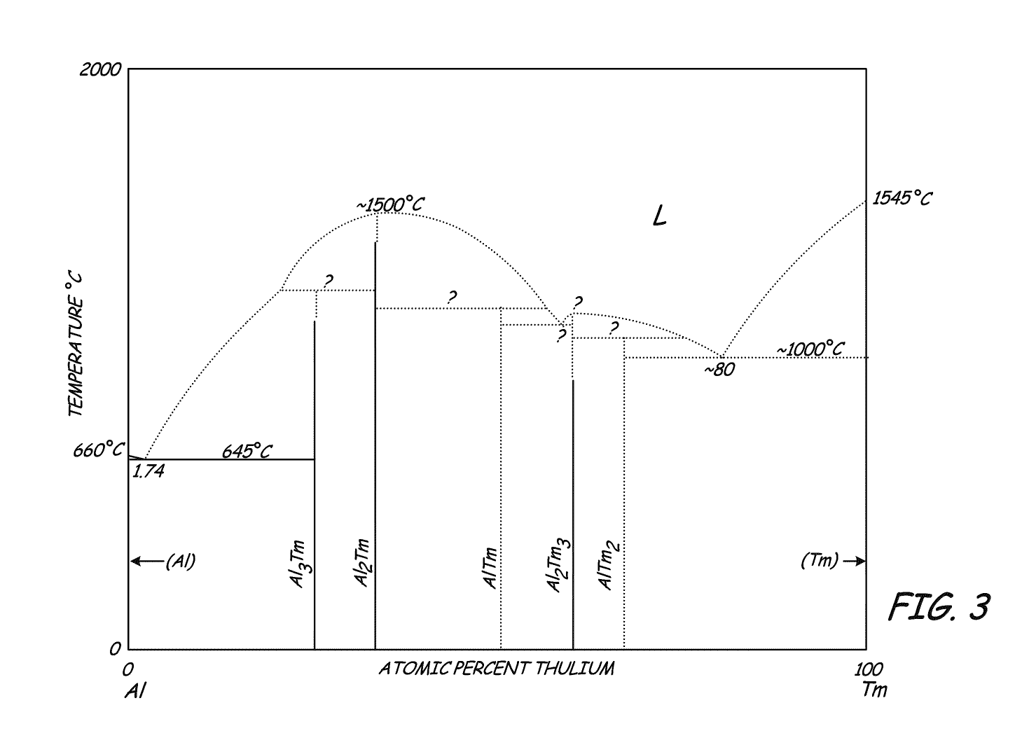

The amount of thulium present in the alloys, if any, may vary from about 0.1 to about 15 weight percent, more preferably from about 0.2 to about 10 weight percent, and even more preferably from about 0.4 to about 6 weight percent. The Al—Tm phase diagram shown in FIG. 3 indicates a eutectic reaction at about 10 weight percent thulium at about 1193° F. (645° C.). Thulium forms metastable Al₃Tm dispersoids in the aluminum matrix that have an L1₂ structure in the equilibrium condition. The Al₃Tm dispersoids have a low diffusion coefficient, which makes them thermally stable and highly resistant to coarsening. Aluminum alloys with less than 10 weight percent thulium can be quenched from the melt to retain thulium in solid solution that may precipitate as dispersed metastable L1₂ intermetallic Al₃Tm following an aging treatment. Alloys with thulium in excess of the eutectic composition can only retain Tm in solid solution by rapid solidification processing (RSP) where cooling rates are in excess of about 10³° C./second.

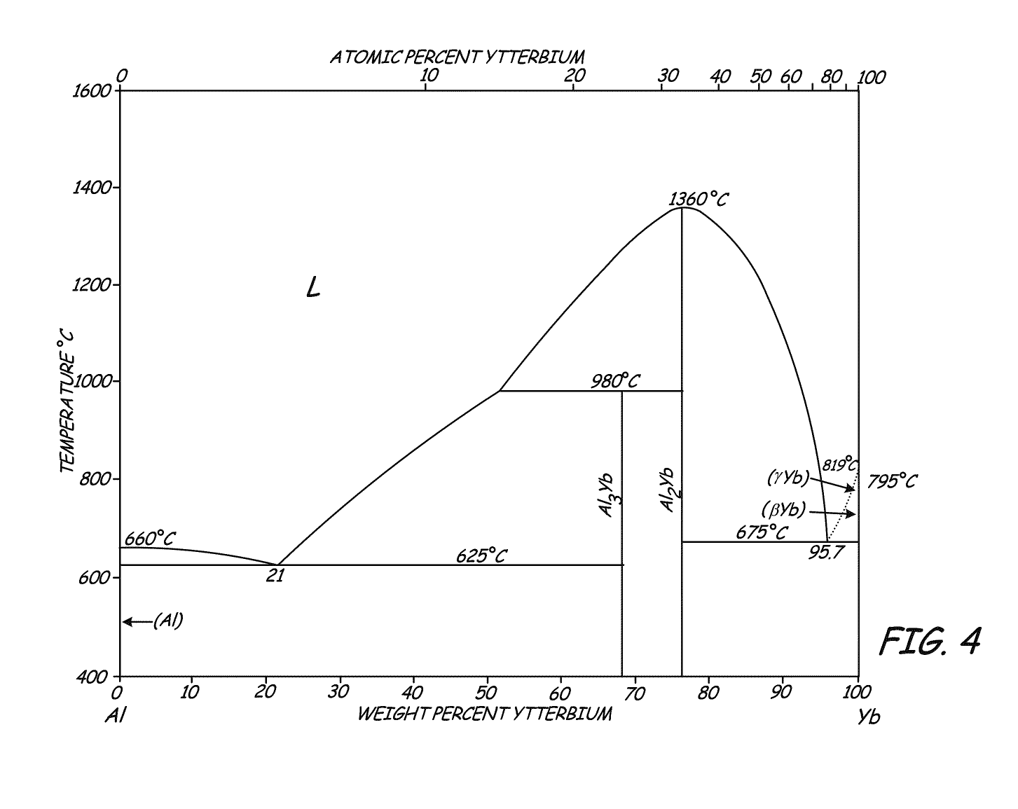

The amount of ytterbium present in the alloys, if any; may vary from about 0.1 to about 25 weight percent, more preferably from about 0.3 to about 20 weight percent, and even more preferably from about 0.4 to about 10 weight percent. The Al—Yb phase diagram shown in FIG. 4 indicates a eutectic reaction at about 21 weight percent ytterbium at about 1157° F. (625° C.). Aluminum alloys with less than about 21 weight percent ytterbium can be quenched from the melt to retain ytterbium in solid solution that may precipitate as dispersed L1₂ intermetallic Al₃Yb following an aging treatment. Alloys with ytterbium in excess of the eutectic composition can only retain ytterbium in solid solution by rapid solidification processing (RSP) where cooling rates are in excess of about 10³° C./second.

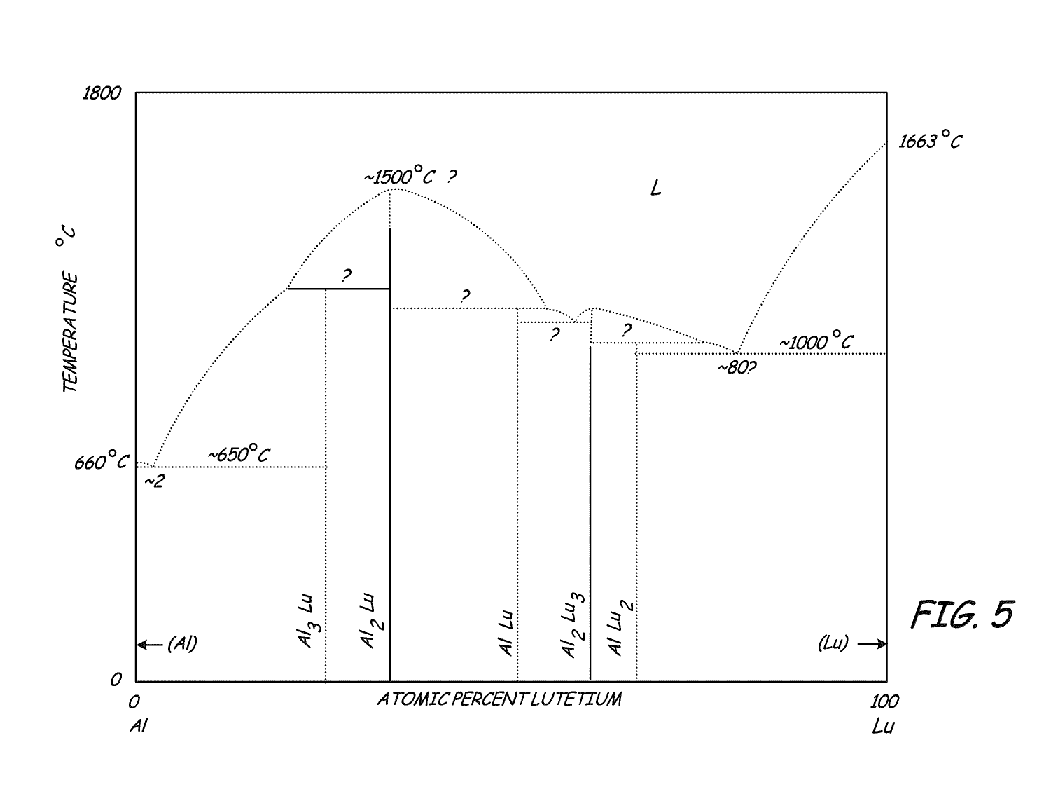

The amount of lutetium present in the alloys, if any, may vary from about 0.1 to about 25 weight percent, more preferably from about 0.3 to about 20 weight percent, and even more preferably from about 0.4 to about 10 weight percent. The Al—Lu phase diagram shown in FIG. 5 indicates a eutectic reaction at about 11.7 weight percent Lu at about 1202° F. (650° C.). Aluminum alloys with less than about 11.7 weight percent lutetium can be quenched from the melt to retain Lu in solid solution that may precipitate as dispersed L1₂ intermetallic Al₃Lu following an aging treatment. Alloys with Lu in excess of the eutectic composition can only retain Lu in solid solution by rapid solidification processing (RSP) where cooling rates are in excess of about 10³° C./second.

The amount of gadolinium present in the alloys, if any, may vary from about 0.1 to about 20 weight percent, more preferably from about 0.3 to about 15 weight percent, and even more preferably from about 0.5 to about 10 weight percent.

The amount of yttrium present in the alloys, if any, may vary from about 0.1 to about 20 weight percent, more preferably from about 0.3 to about 15 weight percent, and even more preferably from about 0.5 to about 10 weight percent.

The amount of zirconium present in the alloys, if any, may vary from about 0.05 to about 4 weight percent, more preferably from about 0.1 to about 3 weight percent, and even more preferably from about 0.3 to about 2 weight percent.

The amount of titanium present in the alloys, if any, may vary from about 0.05 to about 10 weight percent, more preferably from about 0.2 to about 8 weight percent, and even more preferably from about 0.4 to about 4 weight percent.

The amount of hafnium present in the alloys, if any, may vary from about 0.05 to about 10 weight percent, more preferably from about 0.2 to about 8 weight percent, and even more preferably from about 0.4 to about 5 weight percent.

The amount of niobium present in the alloys, if any, may vary from about 0.05 to about 5 weight percent, more preferably from about 0.1 to about 3 weight percent, and even more preferably from about 0.2 to about 2 weight percent.

In order to have the best properties for the fine grain matrix, it is desirable to limit the amount of other elements. Specific elements that should be reduced or eliminated include no more than about 0.1 weight percent iron, 0.1 weight percent chromium, 0.1 weight percent vanadium, and 0.1 weight percent cobalt. The total quantity of additional elements should not exceed about 1% by weight, including the above listed impurities and other elements.

### 2. L1₂ Alloy Powder Formation and Consolidation

The highest cooling rates observed in commercially viable processes are achieved by gas atomization of molten metals to produce powder. Gas atomization is a two fluid process wherein a stream of molten metal is disintegrated by a high velocity gas stream. The end result is that the particles of molten metal eventually become spherical due to surface tension and finely solidify in powder form. Heat from the liquid droplets is transferred to the atomization gas by convection. The solidification rates, depending on the gas and the surrounding environment, can be very high and can exceed 10⁶° C./second. Cooling rates greater than 10³° C./second are typically specified to ensure supersaturation of alloying elements in gas atomized L1₂ aluminum alloy powder in the inventive process described herein.

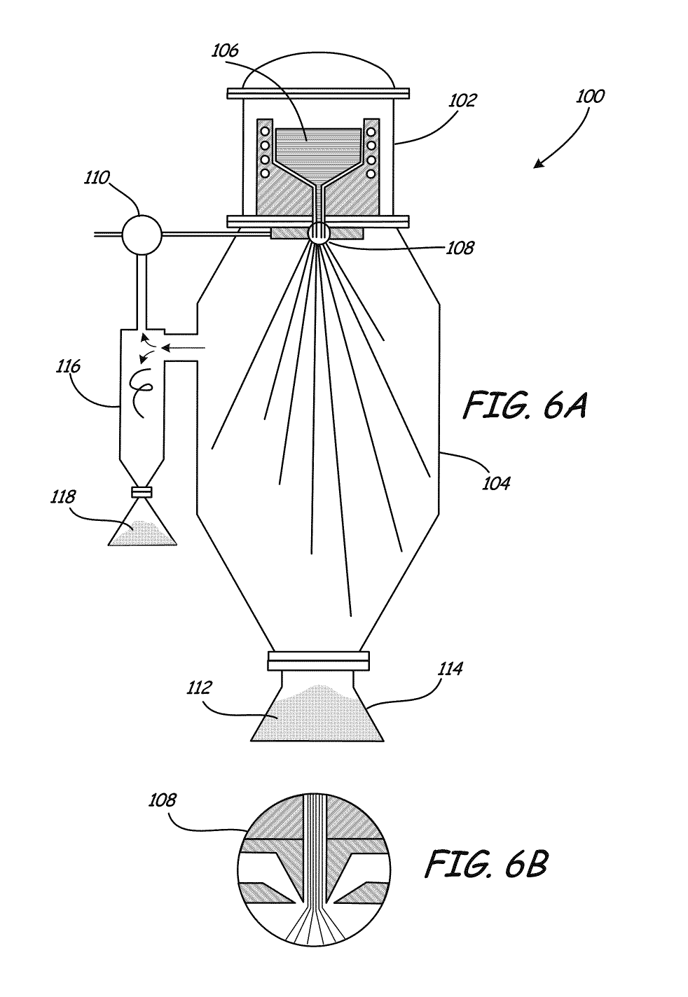

A schematic of typical vertical gas atomizer 100 is shown in FIG. 6A. FIG. 6A is taken from R. Germain, Powder Metallurgy Science Second Edition MPIF (1994) (chapter 3, p. 101) and is included herein for reference. Vacuum or inert gas induction melter 102 is positioned at the top of free flight chamber 104. Vacuum induction melter 102 contains melt 106 which flows by gravity or gas overpressure through nozzle 108. A close up view of nozzle 108 is shown in FIG. 6B. Melt 106 enters nozzle 108 and flows downward till it meets the high pressure gas stream from gas source 110 where it is transformed into a spray of droplets. The droplets eventually become spherical due to surface tension and rapidly solidify into spherical powder 112 which collects in collection chamber 114. The gas recirculates through cyclone collector 116 which collects fine powder 118 before returning to the input gas stream. As can be seen from FIG. 6A, the surroundings to which the melt and eventual powder are exposed are completely controlled.

There are many effective nozzle designs known in the art to produce spherical metal powder. Designs with short gas-to-melt separation distances produce finer powders. Confined nozzle designs where gas meets the molten stream at a short distance just after it leaves the atomization nozzle are preferred for the production of the inventive L1₂ aluminum alloy powders disclosed herein. Higher superheat temperatures cause lower melt viscosity and longer cooling times. Both result in smaller spherical particles.

A large number of processing parameters are associated with gas atomization that affect the final product. Examples include melt superheat, gas pressure, metal flow rate, gas type, and gas purity. In gas atomization, the particle size is related to the energy input to the metal. Higher gas pressures, higher superheat temperatures and lower metal flow rates result in smaller particle sizes. Higher gas pressures provide higher gas velocities for a given atomization nozzle design.

To maintain purity, inert gases are used, such as helium, argon, and nitrogen. Helium is preferred for rapid solidification because the high heat transfer coefficient of the gas leads to high quenching rates and high supersaturation of alloying elements.

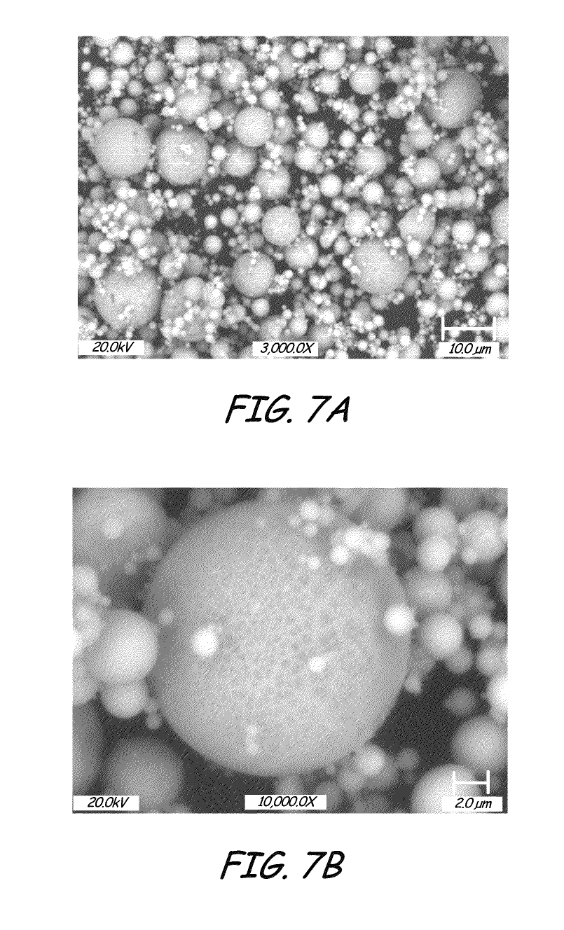

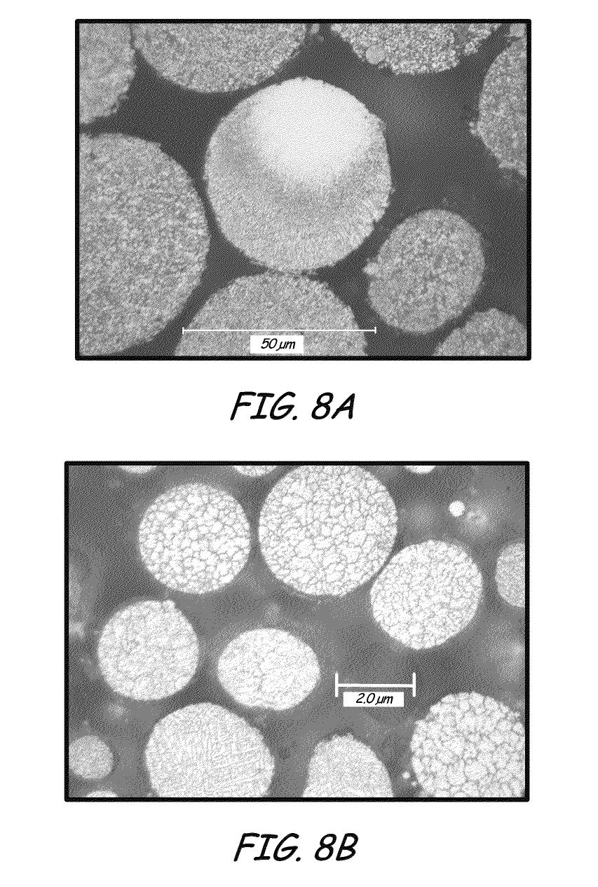

Lower metal flow rates and higher gas flow ratios favor production of finer powders. The particle size of gas atomized melts typically has a log normal distribution. In the turbulent conditions existing at the gas/metal interface during atomization, ultra fine particles can form that may reenter the gas expansion zone. These solidified fine particles can be carried into the flight path of molten larger droplets resulting in agglomeration of small satellite particles on the surfaces of larger particles. An example of small satellite particles attached to inventive spherical L1₂ aluminum alloy powder is shown in the scanning electron microscopy (SEM) micrographs of FIGS. 7A and 7B at two magnifications. The spherical shape of gas atomized aluminum powder is evident. The spherical shape of the powder is suggestive of clean powder without excessive oxidation. Higher oxygen in the powder results in irregular powder shape. Spherical powder helps in improving the flowability of powder which results in higher apparent density and tap density of the powder. The satellite particles can be minimized by adjusting processing parameters to reduce or even eliminate turbulence in the gas atomization process. The microstructure of gas atomized aluminum alloy powder is predominantly cellular as shown in the optical micrographs of cross-sections of the inventive alloy in FIGS. 8A and 8B at two magnifications. The rapid cooling rate suppresses dendritic solidification common at slower cooling rates resulting in a finer microstructure with minimum alloy segregation.

Oxygen and hydrogen in the powder can degrade the mechanical properties of the final part. It is preferred to limit the oxygen in the L1₂ alloy powder to about 1 ppm to 2000 ppm. Oxygen is intentionally introduced as a component of the helium gas during atomization. An oxide coating on the L1₂ aluminum powder is beneficial for two reasons. First, the coating prevents agglomeration by contact sintering and secondly, the coating inhibits the chance of explosion of the powder. A controlled amount of oxygen is important in order to provide good ductility and fracture toughness in the final consolidated material. Hydrogen content in the powder is controlled by ensuring the dew point of the helium gas is low. A dew point of about minus 50° F. (minus 45.5° C.) to minus 100° F. (minus 73.3° C.) is preferred.

In preparation for final processing, the powder is classified according to size by sieving. To prepare the powder for sieving, if the powder has zero percent oxygen content, the powder may be exposed to nitrogen gas which passivates the powder surface and prevents agglomeration. Finer powder sizes result in improved mechanical properties of the end product. While minus 325 mesh (about 45 microns) powder can be used, minus 450 mesh (about 30 microns) powder is a preferred size in order to provide good mechanical properties in the end product. During the atomization process, powder is collected in collection chambers in order to prevent oxidation of the powder. Collection chambers are used at the bottom of atomization chamber 104 as well as at the bottom of cyclone collector 116. The powder is transported and stored in the collection chambers also. Collection chambers are maintained under positive pressure with nitrogen gas which prevents oxidation of the powder.

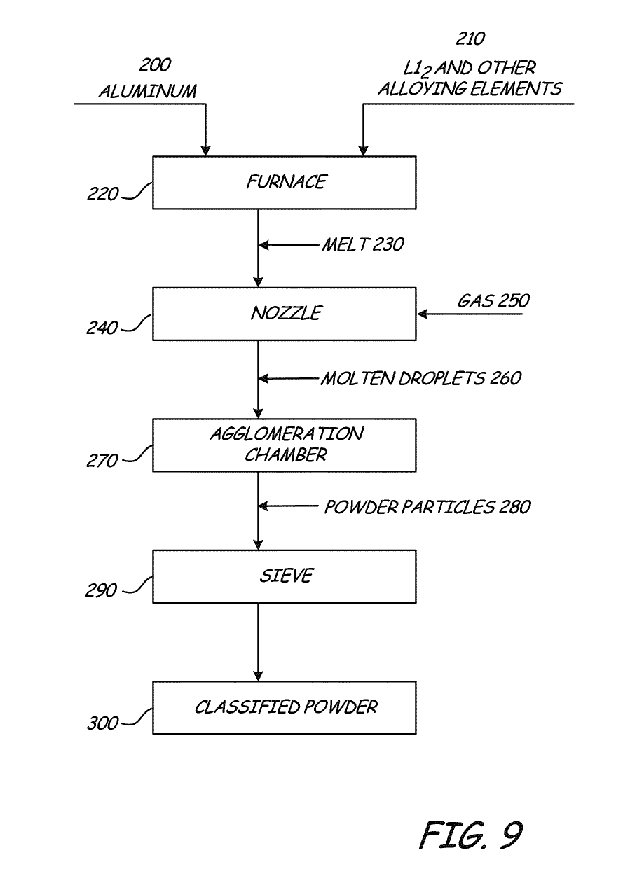

A schematic of the L1₂ aluminum powder manufacturing process is shown in FIG. 9. In the process aluminum 200 and L12 forming (and other alloying) elements 210 are melted in furnace 220 to a predetermined superheat temperature under vacuum or inert atmosphere. Preferred charge for furnace 220 is prealloyed aluminum 200 and L1₂ and other alloying elements before charging furnace 220. Melt 230 is then passed through nozzle 240 where it is impacted by pressurized gas stream 250. Gas stream 250 is an inert gas such as nitrogen, argon or helium, preferably helium. Melt 230 can flow through nozzle 240 under gravity or under pressure. Gravity flow is preferred for the inventive process disclosed herein. Preferred pressures for pressurized gas stream 250 are about 50 psi (10.35 MPa) to about 750 psi (5.17 MPa) depending on the alloy.

The atomization process creates molten droplets 260 which rapidly solidify, as they travel through agglomeration chamber 270 forming spherical powder particles 280. The molten droplets transfer heat to the atomizing gas by convention. The role of the atomizing gas is two fold: one is to disintegrate the molten metal stream into fine droplets by transferring kinetic energy from the gas to the melt stream and the other is to extract heat from the molten droplets to rapidly solidify them into spherical powder. The solidification time and cooling rate vary with droplet size. Larger droplets take longer to solidify and their resulting cooling rate is lower. On the other hand, the atomizing gas will extract heat efficiently from smaller droplets resulting in a higher cooling rate. Finer powder size is therefore preferred as higher cooling rates provide finer microstructures and higher mechanical properties in the end product. Higher cooling rates lead to finer cellular microstructures which are preferred for higher mechanical properties. Finer cellular microstructures result in finer grain sizes in consolidated product. Finer grain size provides higher yield strength of the material through the Hall-Petch strengthening model.

Key process variables for gas atomization include superheat temperature, nozzle diameter, helium content and dew point of the gas, and metal flow rate. Superheat temperatures of from about 150° F. (66° C.) to 200° F. (93° C.) are preferred. Nozzle diameters of about 0.07 in. (1.8 mm) to 0.12 in. (3.0 mm) are preferred depending on the alloy. The gas stream used herein was a helium nitrogen mixture containing 74 to 87 vol. % helium. The metal flow rate ranged from about 0.8 lb/min (0.36 kg/min) to 4.0 lb/min (1.81 kg/min). The oxygen content of the L1₂ aluminum alloy powders was observed to consistently decrease as a run progressed. This is suggested to be the result of the oxygen gettering capability of the aluminum powder in a closed system. The dew point of the gas was controlled to minimize hydrogen content of the powder. Dew points in the gases used in the examples ranged from −10° F. (−23° C.) to −110° F. (−79° C.).

The powder is then classified by sieving process 290 to create classified powder 300. Sieving of powder is performed under an inert environment to minimize oxygen and hydrogen pickup from the environment. While the yield of minus 450 mesh powder is extremely high (95%), there are always larger particle sizes, flakes and ligaments that are removed by the sieving. Sieving also ensures a narrow size distribution and provides a more uniform powder size. Sieving also ensures that flaw sizes cannot be greater than minus 450 mesh which will be required for nondestructive inspection of the final product.

Processing parameters of exemplary gas atomization runs are listed in Table 1.

TABLE 1
Gas atomization parameters used for producing powder

| | | | | | | | Oxygen | |
|---|---|---|---|---|---|---|---|---|
| | Nozzle | He | Gas | | Charge | Average Metal | Content | Oxygen |
| | Diameter | Content | Pressure | Dew Point | Temperature | Flow Rate | (ppm) | Content |
| Run | in (cm) | (vol %) | psi (MPa) | ° F. (° C.) | ° F. (° C.) | lbs/min (kg/min) | Start | (ppm) End |
| 1 | 0.10 (0.25) | 79 | 190 (1.31) | <−58 (−50) | 2200 (1204) | 2.8 (1.27) | 340 | 35 |
| 2 | 0.10 (0.25) | 83 | 192 (1.32) | −35 (−37) | 1635 (891) | 0.8 (.36) | 772 | 27 |
| 3 | 0.09 (0.25) | 78 | 190 (1.31) | −10 (−23) | 2230 (1221) | 1.4 (.64) | 297 | <0.01 |
| 4 | 0.09 (0.25) | 85 | 160 (1.10) | −38 (−39) | 1845 (1007) | 2.2 (1.0) | 22 | 4.1 |
| 5 | 0.10 (0.25) | 86 | 207 (1.43) | −88 (−67) | 1885 (1029) | 3.3 (1.5) | 286 | 208 |
| 6 | 0.09 (0.25) | 86 | 207 (1.43) | −92 (−69) | 1915 (1046) | 2.6 (1.2) | 145 | 88 |

The role of powder quality is extremely important to produce material with higher strength and ductility. Powder quality is determined by powder size, shape, size distribution, oxygen content, hydrogen content, and alloy chemistry. Over fifty gas atomization runs were performed to produce the inventive powder with finer powder size, finer size distribution, spherical shape, and lower oxygen and hydrogen contents. Processing parameters of some exemplary gas atomization runs are listed in Table 1. It is suggested that the observed decrease in oxygen content is attributed to oxygen gettering by the powder as the runs progressed.

Inventive L1₂ aluminum alloy powder was produced with over 95% yield of minus 450 mesh (30 microns) which includes powder from about 1 micron to about 30 microns. The average powder size was about 10 microns to about 15 microns. As noted above, finer powder size is preferred for higher mechanical properties. Finer powders have finer cellular microstructures. As a result, finer cell sizes lead to finer grain size by fragmentation and coalescence of cells during powder consolidation. Finer grain sizes produce higher yield strength through the Hall-Petch strengthening model where yield strength varies inversely as the square root of the grain size. It is preferred to use powder with an average particle size of 10-15 microns. Powders with a powder size less than 10-15 microns can be more challenging to handle due to the larger surface area of the powder. Powders with sizes larger than 10-15 microns will result in larger cell sizes in the consolidated product which, in turn, will lead to larger grain sizes and lower yield strengths.

Powders with narrow size distributions are preferred. Narrower powder size distributings produce product microstructures with more uniform grain size. Spherical powder was produced to provide higher apparent and tap densities which help in achieving 100% density in the consolidated product. Spherical shape is also an indication of cleaner and lower oxygen content powder. Lower oxygen and lower hydrogen contents are important in producing material with high ductility and fracture toughness. Although it is beneficial to maintain low oxygen and hydrogen content in powder to achieve good mechanical properties, lower oxygen may interfere with sieving due to self sintering. An oxygen content of about 25 ppm to about 500 ppm is preferred to provide good ductility and fracture toughness without any sieving issue. Lower hydrogen is also preferred for improving ductility and fracture toughness. It is preferred to have about 25-200 ppm of hydrogen in atomized powder by controlling the dew point in the atomization chamber. Hydrogen in the powder is further reduced by heating the powder in vacuum. Lower hydrogen in final product is preferred to achieve good ductility and fracture toughness.

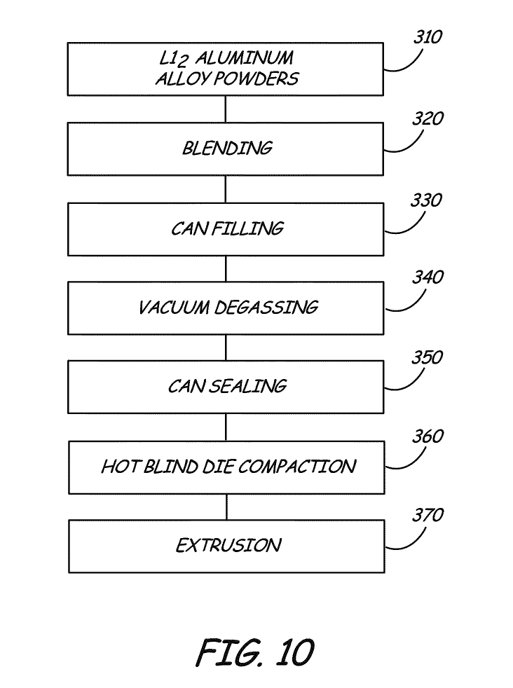

A schematic of the L1₂ aluminum powder consolidation process is shown in FIG. 10. The starting material is sieved and classified L1₂ aluminum alloy powders (step 310). Blending (step 320) is a preferred step in the consolidation process because it results in improved uniformity of particle size distribution. Gas atomized L1₂ aluminum alloy powder generally exhibits a bimodal particle size distribution and cross blending of separate powder batches tends to homogenize the particle size distribution. Blending (step 320) is also preferred when separate metal and/or ceramic powders are added to the L1₂ base powder to form bimodal or trimodal consolidated alloy microstructures.

Following blending (step 320), the powders are transferred to a can (step 330) where the powder is vacuum degassed (step 340) at elevated temperatures. The can (step 330) is an aluminum container having a cylindrical, rectangular or other configuration with a central axis. Cylindrical configurations are preferred with hydraulic extrusion presses. Vacuum degassing times can range from about 0.5 hours to about 8 days. A temperature range of about 300° F. (149° C.) to about 900° F. (482° C.) is preferred. Dynamic degassing of large amounts of powder is preferred to static degassing. In dynamic degassing, the can is preferably rotated during degassing to expose all of the powder to a uniform temperature. Degassing removes oxygen and hydrogen from the powder.

Following vacuum degassing (step 340), the vacuum line is crimped and welded shut (step 350). The powder is then fully densified by blind die compaction or closed die forging as the process is sometimes called (step 360). At this point the can may be removed by machining (step 380) to form a useful billet (step 390).

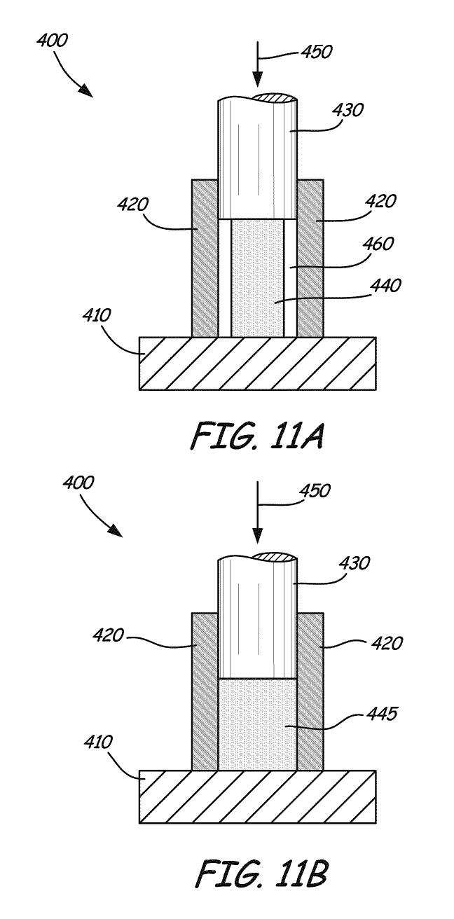

A schematic showing blind die compaction (process 400) is shown in FIGS. 11A and 11B. The equipment comprises base 410, die 420, ram 430, and means to apply pressure to ram 430 indicated by arrow 450. Prior to compaction, billet 440 does not fill die cavity 460. After compaction, billet 445 completely fills the die cavity and has taken the shape of die cavity 460. The die cavities can have any shape provided they have a central symmetrical axis parallel to arrow 450. Cylindrical shapes adopt well for extrusion billets. Canned L1₂ aluminum alloy powder preforms are easily densified due to the large capacity of modern hydraulic presses.

### 3. Forging of L1₂ Consolidated Alloys

Conventional Forging such as drop and hammer forging is performed at high strain rates where adiabatic heating may result in loss of strength due to microstructural coarsening. Isothermal forging at moderate to low strain rates offers the same microstructural refinement due to forging deformation but eliminates the chance for adiabatic heating. Forging can be with or without a die depending on the required forged billet shape using conventional forging or isothermal forging.

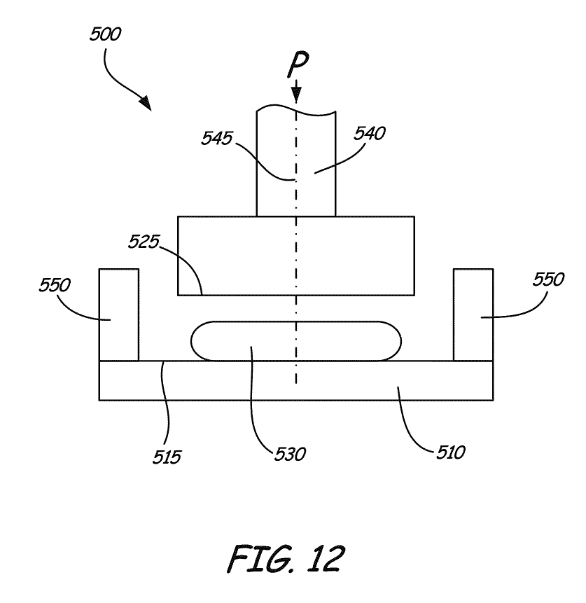

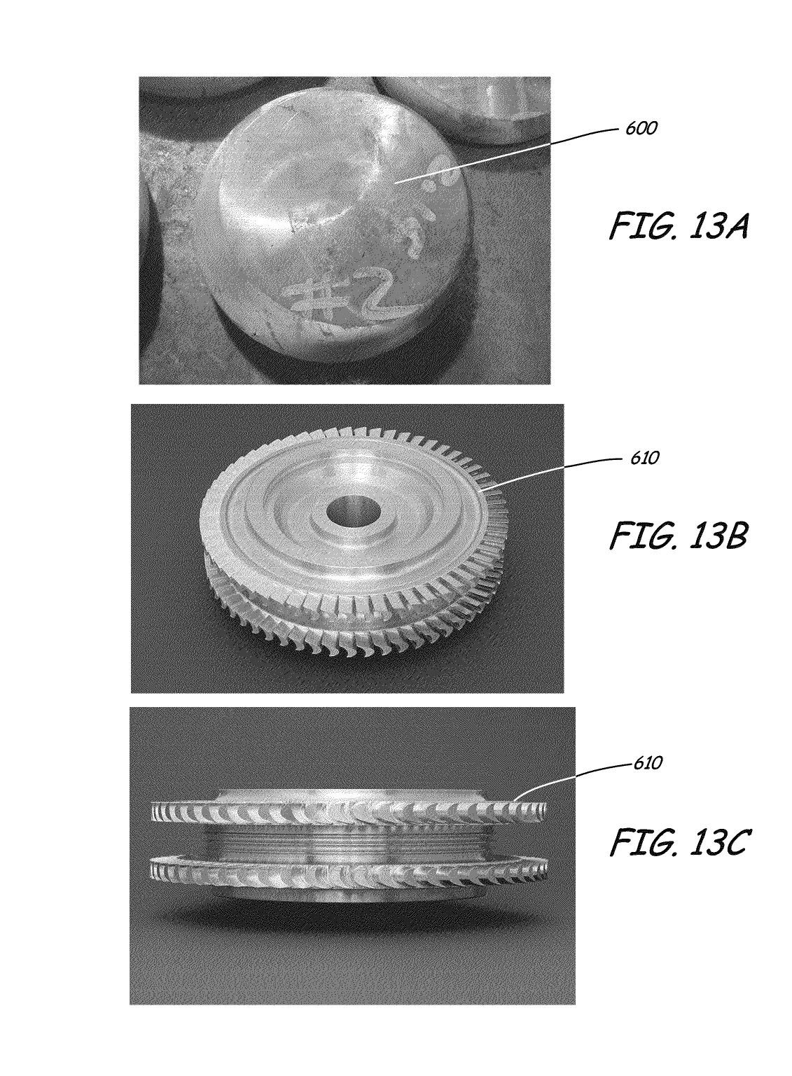

A schematic sketch of forging operation 500 is shown in FIG. 12. Forging operation 500 comprises bottom die 510, upper die 520, and press mechanism 540. During forging, press mechanism 540 applies pressure P to upper die 520 and moves movable upper die 520 toward billet 530 along axis 545 and compresses billet 540 decreasing the thickness of billet 540 and impressing the features of bottom die face 515 and upper die face 525 on billet 530. This type of forging is termed open die or pancake forging wherein billet 540 expands radially in all directions in the absence of any constraints. If bottom die 510 contained vertical constraints (walls) 550 that limit the deformation of billet 530 to a constant volume defined by walls 550, forging operation 500 is termed closed die forging. It is to be understood that bottom die 510 could be a moveable die attached to press mechanism 540 and upper die 520 could be a fixed die. Press mechanism 540 is commonly a hydraulic mechanism because of the capacity of modern hydraulic presses.

Consolidated L1₂ alloy powder can be directly forged but the mechanical properties are inferior to consolidated powder that has been extruded before forging. In the examples discussed herein, the starting workpieces were consolidated L1₂ powders in aluminum cans. The cans were removed by machining and the billets were extruded through a rectangular die to produce billets with rectangular cross sections that were then isothermally vacuum forged in a hydraulic press with heated platens. Forging parameters that result in L1₂ alloys with improved mechanical properties have been developed and are discussed here. Forging parameters include billet temperature, billet soak time, forging rate, reduction and temperature. All forging results were obtained by open die pancake forging.

Table 2 shows the effect of forging parameters on tensile properties of an Al-5.0Cu-1.5Mg-1.0Li-0.45Sc-0.21Nb-0.2Zr (all in wt %) alloy. Forging temperature was varied from 475° F. (246° C.) to 650° F. (243° C.), strain rate varied from 0.1 to 0.4 inch per minute and deformation was maintained constant at about 85% for these examples. Yield strengths of 103-106 ksi (710-731 MPa), tensile strengths of 108-114 ksi (745-786 MPa) and elongations of 9-12 percent were observed for this alloy.

TABLE 2
Al—5.0Cu—1.5Mg—1.0Li—0.45Sc—0.21Nb—0.2Zr
alloy

| | Forging | Strain Rate, | | Yield | Tensile | |
|---|---|---|---|---|---|---|
| Sample | Temperature, | inch/min | | Strength, | Strength, ksi | |
| ID | ° F. (° C.) | (mm/min) | Deformation, % | ksi (MPa) | (MPa) | Elongation, % |
| 1 | 650 (343) | 0.1 (2.5) | 86 | 102.5 (707) | 110 (758) | 9.5 |
| 2 | 650 (343) | 0.1 (2.5) | 86 | 104 (717) | 111 (756) | 9 |
| 3 | 475 (246) | 0.1 (2.5) | 85 | 105 (724) | 112 (772) | 11 |
| 4 | 475 (246) | 0.4 (10.2) | 84 | 103.5 (714) | 108 (745) | 11.4 |
| 5 | 475 (246) | 0.4 (10.2) | 84 | 106 (731) | 112 (776) | 12 |
| 6 | 475 (246) | 0.4 (10.2) | 85 | 105.5 (736) | 114 (786) | 10.5 |

Table 3 shows the effect of forging parameters on tensile properties of an Al-6.0Mg-2.0Sc-1.5Nb-1.5Zr (all in wt %) alloy. In this example, forging temperature was varied from 700° F. to 800° F. (371° C. to 427° C.), strain rate varied from 1.5 to 3 inch per minute and deformation varied from 50 to 70 percent. In this case, yield strengths of 98-105 ksi (676-724 MPa), tensile strengths of 104-112 ksi (717-772 MPa) and elongations of 9-11 percent were observed.

TABLE 3
Al—6.0Mg—2.0Sc—1.5Nb—1.5Zr (all in wt. %)

| | | Strain | | | | |
|---|---|---|---|---|---|---|
| | Forging | rate, | | Yield | Tensile | |
| | Temperature, | in/min | | strength, | Strength, | |
| Billet # | ° F. (° C.) | (cm/min) | Deformation, % | ksi (MPa) | ksi (MPa) | Elongation,% |
| 1 | 750 (399) | 3 (7.6) | 70 | 103 (710) | 110 (758) | 9 |
| 2 | 800 (427) | 3 (7.6) | 70 | 98 (676) | 105 (724) | 11 |
| 3 | 750 (399) | 3 (7.6) | 50 | 102 (703) | 108 (745) | 10.2 |
| 4 | 800 (427) | 3 (7.6) | 50 | 96 (662) | 104 (717) | 10 |
| 5 | 700 (399) | 1.5 (3.8) | 50 | 105 (724) | 112 (772) | 9 |
| 6 | 700 (399) | 1.5 (3.8) | 70 | 104 (717) | 111 (765) | 10.5 |

Table 4 shows another example of the effect of forging parameters on tensile properties of an Al-8.4Ni-2.15Sc-8.8Gd-1.5Zr (all in wt. %) alloy. In this example, forging temperature was varied from 400° F. to 500° F. (204° C. to 260° C.) at constant strain rate of 6 inches (15.2 cm) per minute and deformation of 75 percent. This showed even higher properties with yield strengths of 103-110 ksi (710-758 MPa), tensile strengths of 111-120 ksi (765-827 MPa), elongations of 10-12.5 percent and reductions in area of 19-20 percent.

TABLE 4
Al—8.4Ni—2.15Sc—8.8Gd—1.5Zr (all in wt. %)

| | Forging | Strain rate, | | Yield | Tensile | | |
|---|---|---|---|---|---|---|---|
| | Temperature, | in/min | | strength, ksi | Strength, | | Reduction |
| Billet # | ° F. (° C.) | (cm/min) | Deformation, % | (MPa) | ksi (MPa) | Elongation, % | in Area, % |
| 1 | 400 (204) | 6 (15.2) | 75 | 110 (758) | 120 (827) | 10 | 19 |
| 2 | 450 (232) | 6 (15.2) | 75 | 106 (731) | 115 (793) | 12 | 19.5 |
| 3 | 500 (260) | 6 (15.2) | 75 | 103 (710) | 111 (765) | 12.5 | 20 |

Although the present invention has been described with reference to preferred embodiments, workers skilled in the art will recognize that changes may be made in form and detail without departing from the spirit and scope of the invention.

1. A method for forming a high strength aluminum alloy component containing L1₂ dispersoids, comprising the steps of:
placing in a container a quantity of an aluminum alloy powder containing an L1₂ dispersoid L1₂ comprising Al₃X dispersoids wherein X is at least one first element selected from the group comprising:
about 0.1 to about 4.0 weight percent scandium, about 0.1 to about 20.0 weight percent erbium, about 0.1 to about 15.0 weight percent thulium, about 0.1 to about 25.0 weight percent ytterbium, and about 0.1 to about 25.0 weight percent lutetium;
at least one second element selected from the group comprising about 0.1 to about 20.0 weight percent gadolinium, about 0.1 to about 20.0 weight percent yttrium, about 0.05 to about 4.0 weight percent zirconium, about 0.05 to about 10.0 weight percent titanium, about 0.05 to about 10.0 weight percent hafnium, and about 0.05 to about 5.0 weight percent niobium; and
the balance substantially aluminum;
vacuum degassing the powder at a temperature of about 300° F. (149° C.) to about 900° F. (482° C.) for about 0.5 hours to about 8 days;
sealing the degassed powder in the container under vacuum;
heating the sealed container at about 300° F. (149° C.) to about 900° F. (482° C.) for about 15 minutes to eight hours;
vacuum hot pressing the heated container to form a billet;
removing the container from the formed billet; and
forging the billet into a component with improved strength and fracture toughness.

2. The method of claim 1, wherein the aluminum alloy powder contains at least one metal selected from the group comprising: about 1.0 to about 8.0 weight percent magnesium, (4-25) weight percent silicon, (0.1-3) weight percent manganese, about 0.5 to about 3.0 weight percent lithium, about 0.2 to about 6.0 weight percent copper, about 3.0 to about 12.0 weight percent zinc, and about 1.0 to about 12.0 weight percent nickel.

3. The method of claim 2, wherein the alloy powder has a mesh size of less than 350 mesh.

4. The method of claim 1, wherein the aluminum alloy powder contains at least one ceramic selected from the group comprising: about 5 to about 40 volume percent aluminum oxide, about 5 to about 40 volume percent silicon carbide, about 5 to about 40 volume percent aluminum nitride, about 5 to about 40 volume percent titanium diboride, about 5 to about 40 volume percent titanium boride, about 5 to about 40 volume percent boron carbide, and about 5 to about 40 volume percent titanium carbide.

5. The method of claim 1, wherein the forging is carried out at a temperature of from about 300° F. (149° C.) to about 900° F. (482° C.).

6. The method of claim 1, wherein the forging strain rate is from about 0.1 min⁻¹ to about 25 min⁻¹.

7. The method of claim 1, wherein the tensile strength of forged L1₂ alloy billet is about 120 ksi (827 MPa).

8. The method of claim 7, wherein the yield strength of forged L1₂ alloy billet is about 110 ksi (758 MPa).

9. The method of claim 7, wherein the elongation of forged L1₂ alloy billet is over 12 percent.

10. The method of claim 1, wherein the forged L1₂ aluminum alloys have tensile strengths of about 40 ksi (276 MPa) at a temperature of 600° F. (316° C.).

11. A high strength aluminum alloy component, comprising:
an aluminum alloy billet containing an L1₂ dispersoid comprising Al₃X dispersoids wherein X is at least one first element selected from the group comprising:
about 0.1 to about 4.0 weight percent scandium, about 0.1 to about 20.0 weight percent erbium, about 0.1 to about 15.0 weight percent thulium, about 0.1 to about 25.0 weight percent ytterbium, and about 0.1 to about 25.0 weight percent lutetium;
at least one second element selected from the group comprising about 0.1 to about 20.0 weight percent gadolinium, about 0.1 to about 20.0 weight percent yttrium, about 0.05 to about 4.0 weight percent zirconium, about 0.05 to about 10.0 weight percent titanium, about 0.05 to about 10.0 weight percent hafnium, and about 0.05 to about 5.0 weight percent niobium; and
the balance substantially aluminum;
the billet being forged into a component with improved strength and fracture toughness.

12. The alloy component of claim 11, wherein the aluminum alloy powder contains at least one metal selected from the group comprising: about 1.0 to about 8.0 weight percent magnesium, (4-25) weight percent silicon, (0.1-3) weight percent manganese, about 0.5 to about 3.0 weight percent lithium, about 0.2 to about 6.0 weight percent copper, about 3.0 to about 12.0 weight percent zinc, and about 1.0 to about 12.0 weight percent nickel.

13. The alloy component of claim 11, wherein the aluminum alloy component powder contains at least one ceramic selected from the group comprising: about 5 to about 40 volume percent aluminum oxide, about 5 to about 40 volume percent silicon carbide, about 5 to about 40 volume percent aluminum nitride, about 5 to about 40 volume percent titanium diboride, about 5 to about 40 volume percent boron carbide, about 5 to about 40 volume percent titanium boride, and about 5 to about 40 volume percent titanium carbide.

14. The alloy component of claim 11, wherein the alloy powder has a mesh size of less than 350 mesh.

15. The alloy component of claim 11, wherein the forging is carried out at a temperature from about 300° F. (149° C.) to about 900° F. (482° C.).

16. The alloy component of claim 11, wherein the forging rate is from about 0.1 min⁻¹ to about 25 min⁻¹.

17. The alloy component of claim 11, wherein the tensile strength of forged L1₂ alloy billet is about 120 ksi (827 MPa).

18. The alloy component of claim 17, wherein the yield strength of forged alloy billet is about 110 ksi (758 MPa).

19. The alloy component of claim 17, wherein the elongation of forged L1₂ alloy billet is over 12 percent.

20. The alloy component of claim 11, wherein the forged L1₂ aluminum alloys have tensile strengths of 40 ksi (276 MPa) at a temperature of 600° F. (316° C.).
